(19) United States
(12) Patent Application Publication
(10) Pub. No.: US 2012/0319899 A1
(43) Pub. Date: Dec. 20, 2012

(54) DYNAMIC SWITCHING TO BIT-SYNCHRONOUS INTEGRATION TO IMPROVE GPS SIGNAL DETECTION

(76) Inventors: Jawaharlal Tangudu, Bangalore (IN); Sunil Chomal, Bangalore (IN); Pradeep Pappinissiri Puthanveetil, Bangalore (IN)

(21) Appl. No.: 13/161,692

(22) Filed: Jun. 16, 2011

(51) Int. Cl. G01S 19/30

(52) U.S. Cl. 342/357.69

(57) ABSTRACT

A method includes determining a bit edge associated with information transmitted through a satellite during a detection operation of a receiver through a processor associated therewith. The method also includes dynamically switching, through the processor, a mode of a signal acquisition of the receiver from a current integration mode of operation of a measurement to a bit-synchronous integration mode of operation of the measurement using a processor when the bit edge is determined.

### FIELD OF TECHNOLOGY

This disclosure relates generally to the technical field of positioning systems and, in one example embodiment, to a system, method and an apparatus to improve the GPS signal detection through dynamically switching to a bit-synchronous integration mode.

### BACKGROUND

Generally, a Global Position System (e.g., a UPS) is not able to locate a receiver in a threshold amount of time when a signal between a satellite and a receiver is obstructed. For example, the receiver may not be able to determine a present location due to interference caused by a surrounding environment (e.g., a canyon environment, an internal environment, a blocked environment, an urban environment, a poor visibility environment).

Knowledge of a bit edge of a navigation message sent by the satellite is not known to the receiver. This creates a synchronization offset between a time period of integration of the signal and time period of transmission of an information data in the signal. For example, the offset can be caused when the receiver uses a different millisecond coherent integration time for signal detection than a period of transmission of a navigation message from the satellite. The synchronization offset causes a decrease in the efficiency of the receiver (e.g., signal detection capability, time to receive first position fix, start up time, robustness, coverage of receivers' position fix, ability to acquire satellites with low power satellite signals). As a result, the performance of the receiver is inadequate in the surrounding environment.

### SUMMARY

Disclosed are a method, an apparatus and/or a system to improve GPS signal detection through dynamically switching to a bit-synchronous integration mode of operation.

In one embodiment, a method includes determining a bit edge associated with information transmitted through a satellite during a detection operation of a receiver through a processor associated therewith. The method also includes dynamically switching, through the processor, a mode of a signal acquisition by the receiver from a current integration mode of operation of a measurement to a bit-synchronous integration mode of operation of the measurement using a processor when the bit edge is determined.

In another embodiment, a receiver includes a detection module to determine a bit edge during a high-sensitivity dwell operation of the receiver in which a satellite is identified. The receiver also includes a switching module to switch from a current integration mode of operation of a measurement to a bit-synchronous integration mode of operation of the measurement using a processor when the bit edge is determined during the high-sensitivity dwell operation of the receiver.

In another embodiment, a global positioning system includes a satellite to generate a satellite signal. The global positioning system also includes a receiver to switch from a current integration mode of operation of a measurement to a bit-synchronous integration mode of operation of the measurement when a bit edge of the satellite signal is determined during a detection operation of the receiver.

### BRIEF DESCRIPTION OF THE DRAWINGS

Example embodiments are illustrated by way of example and not limitation in the figures of the accompanying drawings, in which like references indicate similar elements and in which:

FIG. 1 is a collective view of a positioning system, a surrounding environment and a receiver with a switching module receiving a satellite signal from a plurality of satellites, in one or more embodiments;

FIG. 2 is a diagram of a hypothesis search space in 2 dimensions with one dimension indicating the code phase and the other dimension indicating the Doppler frequency, in one or more embodiments;

FIG. 3 is a structural diagram of the transmitted signal from the satellite with the information message, in one or more embodiments;

FIG. 4 is a flow diagram portraying the various processes involved in a typical signal acquisition strategy, in one or more embodiments;

FIG. 5 is a diagram illustrating a current integration mode of operation, in one or more embodiments;

FIG. 6 is a diagram explaining a bit-synchronous mode of operation and the dynamic switch from current integration mode of operation to a bit-synchronous mode of operation, in one or more embodiments;

FIG. 7 is a diagram projecting the bit edge related losses while using a current integration mode and an elimination of the bit edge related losses using current integration mode of operation, in one or more embodiments;

FIG. 8 is a flow diagram showing the processes involved in the novelty signal acquisition strategy in comparison to the typical signal acquisition strategy, in one or more embodiments;

FIG. 9 is a diagram showing a switch to bit-synchronous mode of operation in a new dwell other than the dwell in which the bit edge information is determined, in one or more embodiments;

FIG. 10 is a time line diagram of the various operations in an acquisition process with the switch to bit-synchronous mode of operation from current integration mode of operation, in one or more embodiments;

FIG. 11 is a graph showing the probability of detection at various input powers with no switching and with switching enabled in the current integration mode of operation; and

FIG. 12 is a block diagram showing an exploded view of the receiver of FIG. 1 with interaction between the switching module and a set of other modules of the receiver.

Other features of the present embodiments will be apparent from accompanying drawings and from the detailed description that follows.

### DETAILED DESCRIPTION

A method, system and an apparatus to improve a GPS signal detection through dynamically switching to a bit-synchronous integration mode of operation is disclosed. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

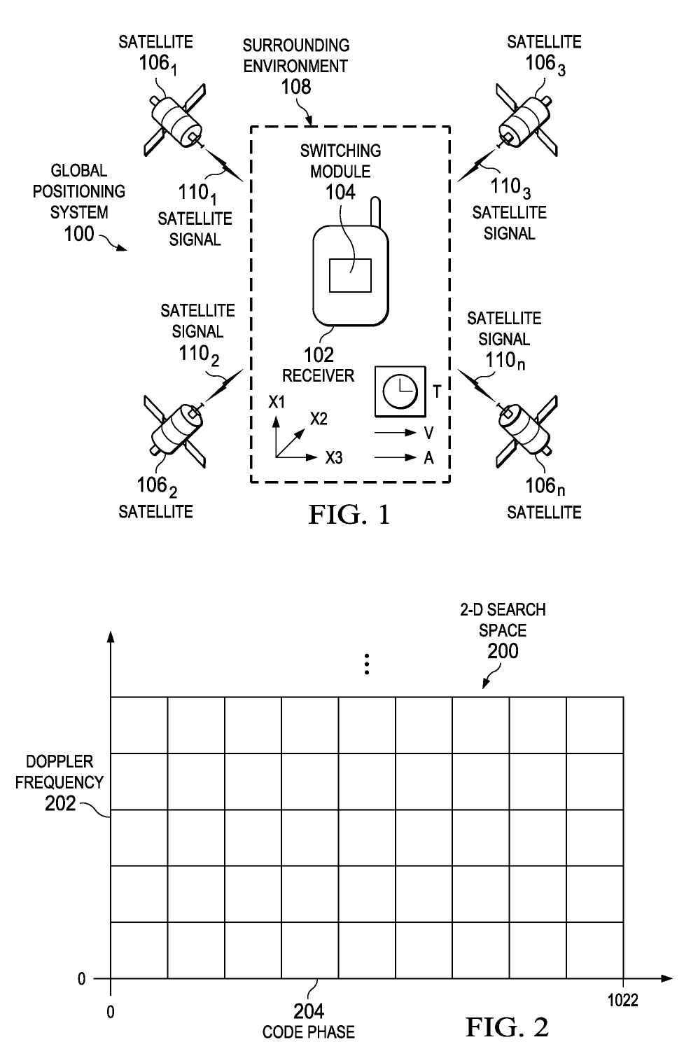

FIG. 1 is a collective view of a positioning system 100, a surrounding environment 108, and a receiver 102 with a switching module 104 receiving satellite signals 110₁₋ₙ from a plurality of satellites 106₁₋ₙ according to one of more embodiments. The receiver 102, receives a signal from one or more of a celestial body orbiting another celestial body to determine a position, a velocity, an acceleration, a direction, a time and/or a navigation information for worldwide users on a continuous basis at any location on and proximate to a surface of the celestial body orbiting another celestial body. For example, a GPS receiver receives a GPS satellite signal from a plurality of GPS satellites which may be used by the GPS receiver to determine its position or velocity with respect to time.

If the celestial body orbiting another celestial body is a satellite 106, then a power level of the satellite signals 110₁₋ₙ, received by receiver 102 (used as received power level hereafter) may vary, even though the satellites 106₁₋ₙ transmit the satellite signals 110₁₋ₙ with the same power. For example, the received power level of satellite signal 110₁ is −149 dBm and the received power levels of the remaining satellite signals 110₂₋ₙ is −154 dBm, −156 dBm and −157dBm. The variation in the received power levels of each of the satellite signals 110₁₋ₙ is a result of interference by the surrounding environment 108. The interference is a signal level interference caused by the surrounding environment 108 or a visibility interference caused by the surrounding environment 108 blocking the signal transmission path of satellite signals 110₁₋ₙ between the satellite 106 and the receiver 102, wholly or partially.

The satellite signal with the power level that is higher than the power levels of other satellite signals received by the receiver 102 is termed as high power satellite signal and the other satellite signals that are received is termed as low power satellite signals. For example, when the received power level of satellite signal 110₁ is −149 dBm and the received power levels of the remaining satellite signals 110₂₋ₙ are −154 dBm, −156 dBm and −157 dBm, the satellite signal 110₁ is termed as high power satellite signal and the satellite signals 110₂₋ₙ are termed as low power satellite signals. The satellite 106 associated with the high power satellite signal is termed as a high power satellite and the satellite 106 associated with the low power satellite signals are termed as a low power satellite. Even if all the satellites 106₁₋ₙ in the system transmit the satellite signal at the same power level, the satellites are classified as the low power satellites and the high power satellites based on the signal strength of the satellite signals 110₁₋ₙ (transmitted by the satellites) received by the receiver 102.

The receiver 102 is configured to determine the navigation, timing, direction, and/or position, upon detection of a threshold number of satellites. For example, in a GPS system a threshold number of satellites to obtain the navigation related position, orientation, and/or time data may be four satellites. The threshold number of satellites includes low power and/or high power satellites. However, if the receiver 102 is not able to detect the threshold number of satellites in a threshold amount of time due to an obstruction by the surrounding environment 108, the switching module 104 in the receiver 102 improves the satellite signal detection ability of the receiver 102 by switching a current signal acquisition strategy 400 used to detect the satellites, from a current integration mode of operation 400 to a bit-synchronous integration mode of operation 630. The improvement in signal detection ability enhances the satellite detection ability of the receiver 102. The surrounding environment 108 is an environment around the receiver 102 that obstructs the satellite signal 110 generated by the satellite 106 wholly or partially from the receiver 102. For example the surrounding environment 108 includes a canyon environment, an internal environment, a blocked environment, an urban environment, and/or a poor visibility environment.

When the receiver 102 is not be able to detect a threshold number of satellites or when the receiver 102 requires a time period longer than the threshold amount of time to detect the threshold number of satellites, then the satellite signal 110 detection ability of the receiver 102 needs to be improved. Switching module 104 is used by the receiver 102 to improve the signal detection capability of the receiver 102.

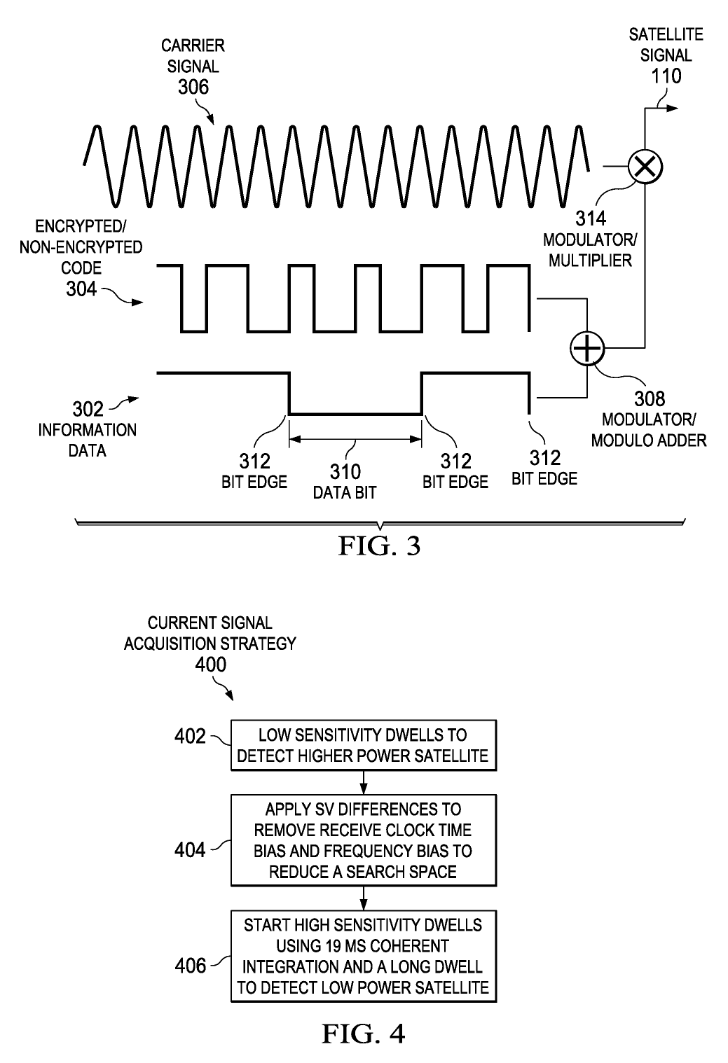

Furthermore, the satellite signal 110 received by the receiver 102 includes an information data 302 (illustrated in FIG. 3) (e.g., navigation message) or alternately the information data 302 is embedded in the satellite signal 110. The information data 302 is used by the receiver 102 to determine the position, navigation, direction and/or timing of the receiver 102.

Recovery of the information data 302 from the satellite signal 110 and/or detecting the threshold number of satellites through the receiver 102 includes three processes that the receiver 102 has to execute. These three processes include a signal conditioning process, a signal acquisition process and a signal tracking process. The receiver 102 searches, acquires and/or track the satellites 106₁₋ₙ, then recover the information data 302 from the satellites and use the information data 302 to determine the position, navigation, direction and/or timing of the receiver 102.

In the signal conditioning process the receiver 102 conditions and amplifies the received satellite signal 110 to be useful for digital processing. Once the received satellite signal 110 is conditioned and well suited for digital processing, the receiver 102 estimates an arrival time, Tₐ, a Doppler shift, f_{d} and a carrier phase offset. Information data described earlier may be used by the receiver 102 to obtain navigation, timing, direction and/or position related data. For example, the arrival time, Tₐ includes information that is used by the receiver 102 to compute the receiver 102 position and clock offset. The Doppler shift, f_{d} includes information that is used by the receiver 102 to compute the receiver 102 velocity and clock frequency and the carrier offset assists the receiver 102 to obtain precision details.

The estimation of the arrival time, the Doppler shift and the carrier offset occurs in two subsequent processes. The initial process performs a search of a large multi dimensional hypothesis search space for obtaining an approximate value of the arrival time Tₐ and the Doppler shift f_{d}. In a global positioning system, the multi-dimensional search space is a 2D search space 200, wherein one of the dimensions of the search space is Doppler frequency 202 and the other dimension is the code phase 204. The process of obtaining the approximate values of arrival time Tₐ and the Doppler shift f_{d} by searching the 2D search space 300 is termed as signal acquisition process. Once the approximate values of arrival time Ta and the Doppler shift f_{d} have been estimated, the 2D search space becomes narrow. The signal tracking is a process that obtains an accurate value of the arrival time Tₐ and the Doppler shift, f_{d}. The receiver 102 obtains the accurate values through the search of the narrow 2D search space. The switching module 104 in the receiver 102 in this application relates to, but is not limited to, the signal acquisition process.

The signal acquisition process performed by the receiver 102 includes cross correlating the received satellite signal 110 and a replica of the satellite signal 110 generated by the receiver 102. In an example embodiment, a satellite signal is also forwarded through another device. The receiver 102 may accumulate the cross correlation results for a time period over numerous iterations. The process of accumulating the correlation results coherently over a time period T_{c} before the satellite 106 is detected is termed as a predetection integration mode of operation. The total time taken for detection is a combination of predetection integration time interval and number of non-coherent integrations. Non coherent integration is an integration operation performed over a set of coherently integrated data. Non coherent integration accumulates the magnitude of the coherently integrated data. Accumulation of the magnitude rather than the value with the sign avoids destructive addition due to a change in bit from positive bit to a negative bit (e.g., +1 to −1 or vice versa) and/or the residual Doppler. For example, if the predetection integration time period is 19 ms and number of non-coherent integrations are 500, then the total time taken for the detection is 19 ms*500=9.5 sec. The predetection integration mode is also called coherent integration mode of operation. The predetection integration time interval T_{c}, is also known as the coherent integration time period.

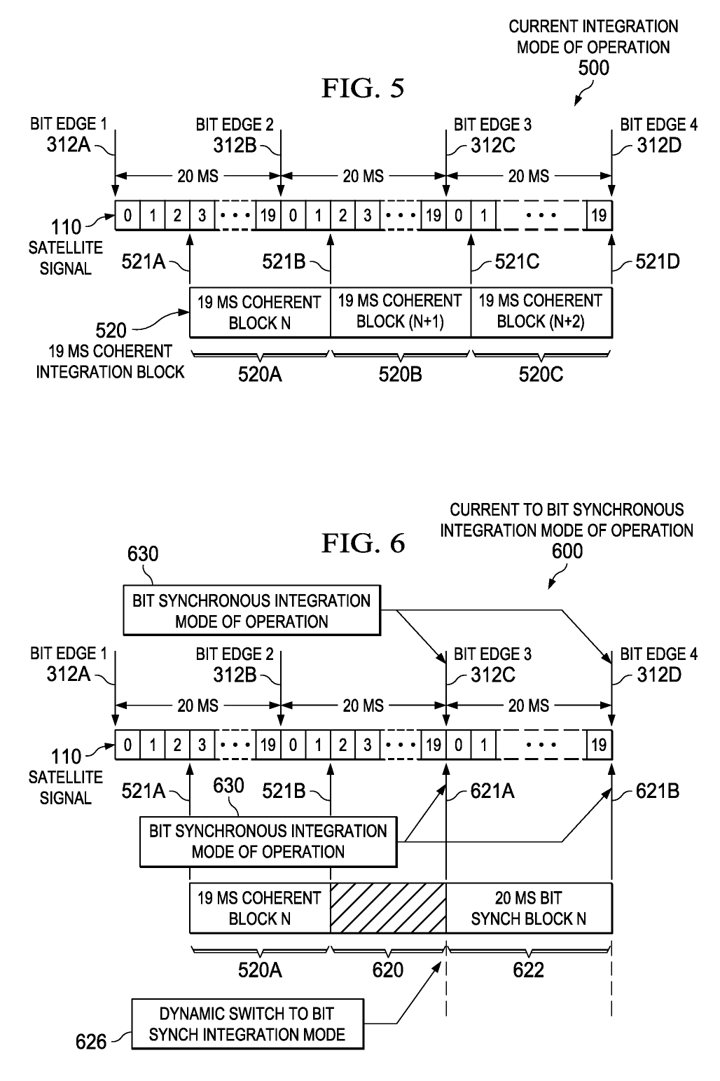

The switching module 104 in the receiver 102 improves the signal detection and/or signal acquisition ability of the receiver 102 by switching the coherent integration mode of operation to a bit-synchronous integration mode of operation 630. The working of the switching module 104, coherent integration mode of operation and the bit-synchronous integration mode of operation 630 are described in the forthcoming FIGS. 8, 5 and 6 respectively. However, a description of the switching module 104, the coherent integration mode of operation and the bit-synchronous integration mode of operation 630 requires an understanding of the structure of the received satellite signal 110, the information data 302 comprising in the satellite signal 110 transmitted by the satellite 106, the bit edge 312 and the bit edge 312 transition.

In FIG. 2 a hypothesis search space 200 has two dimensions for Doppler frequency 202 and arrival time or code phase 204 offset. The hypothesis search space is exhaustive or it is suitably reduced using assistance data that are made available through communication networks. The search is performed over a pair of code phase and Doppler frequency in the search space.

FIG. 3 shows a structure of the satellite signal 110 generated and transmitted by the satellite 106, according to one or more embodiments. The satellite signal 110 received by the receiver 102 is a combination of the satellite signal 110 transmitted by the satellite 106 and interference factors. Since, FIG. 3 explains the inherent structure of the signal transmitted by the satellite 106 without considering the interference factors, the transmitted signal and received signal is termed as the same in this application. When the interference factors are not considered, the transmitted and received signal both are represented as satellite signal 110.

The satellite signal 110 generated and transmitted by the satellite 106, includes an information data 302 (e.g., navigation message), an encrypted or non-encrypted code 304 (e.g., pseudo random noise code, C/A code, P(Y) code) to which the information data 302 is added to (e.g., modulo two addition 308), and a carrier signal 306 on which the code 304 including the information data 302 is multiplied or modulated upon (e.g., BPSK) before transmission using a multiplier or modulator 314. If the satellite 106 is a global positioning satellite, then the information data 302 is termed as a navigation message. The navigation message 302 includes a data bit 310 transmitted at a rate of 50 bits per second or alternately one navigation message data bit 310 is transmitted per 20 msec. In one or more embodiments, a bit 310 is a fundamental unit of information having just two possible values. In the case of the navigation message in the global positioning system, the two possible values that the bit 310 assumes either a +1 or −1. Based on the information transmitted, the bit 310 transitions from a +1 to a −1 value, a −1 to +1 value, a −1 to −1 value or a +1 to +1 value after every 20 ms from the occurrence of a first bit in the navigation message. Each above mentioned transition of bit 310 is associated with a falling or raising edge 312. Each falling or rising bit edge 312 related to the transition of the bit 310 as mentioned before is termed as a bit edge 312.

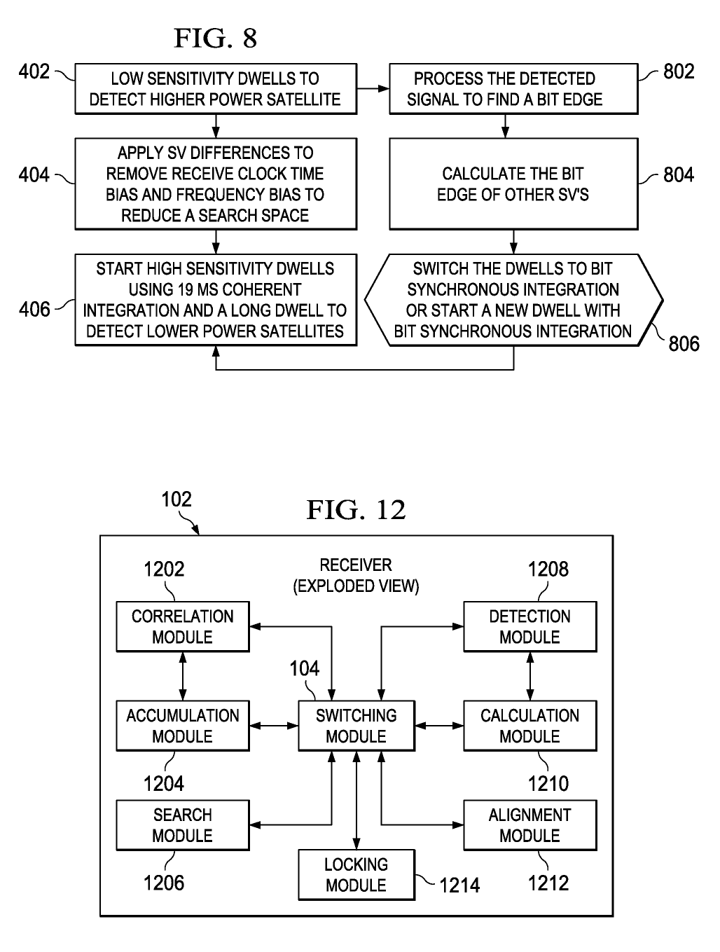

Expounding on the signal acquisition process described in FIG. 1 previously, FIG. 4 shows a flow diagram portraying the various processes involved in a current signal acquisition strategy 400, according to one or more embodiments. The current signal acquisition strategy 400 used for signal acquisition includes three processes. For example, the current signal acquisition strategy is a coarse time assisted scenario strategy. In a course time assisted scenario the receiver 102 is provided with assistance from a reference point. The reference point includes a cell phone tower or a network device. The assistance is in the form of receiver position from the reference point, ephemerides data and/or time information. The ephemerides data includes the satellite position information as a function of time. For example, a GSM cell tower provides a GPS receiver with an ephemerides data suggesting the location of 2 satellites. Satellite 1 is 20000 km from the GPS receiver and the satellite 2 is 21000 km from the GPS receiver at a given time in the example. The GSM cell tower also provides information of the GPS receiver's current location within ±10 km accuracy from the GSM cell tower. The GPS receiver knows the distance between the two satellites as 1000 km from the assistance data it received from the GSM cell tower. When the GPS receiver finds the start of the PN code of the satellite 1, it can calculate the approximate start of the PN code of satellite 2 to be 1000 km±10 km divided by the speed of light. The GPS receiver calculates the start of the PN code of satellite 2 to be within 3.30 ms to 3.36 ms. The above mentioned example may be extended to an explanation of FIG. 8. In FIG. 8, after detecting a high power SV satellite 1 in “402”, satellite 2's PN code alignment is determined approximately to be after 0.3 to 0.36 ms away from where satellite 1 was detected. In an example embodiment, once satellite 1's bit edge is detected in “802”, the bit edge of satellite 2 may be determined to be 3 ms away from the bit edge of satellite 1 and the bit edge of satellite 2 may be calculated. Once the bit edge of satellite 2 is calculated the search is switched to a bit edge aligned search.

In a first process of the current signal acquisition strategy 400, the receiver 102 performs a low-sensitivity dwell mode of operation 402 to detect the high power satellite. The process in which the receiver 102 detects the high power satellite is termed as a low-sensitivity dwell mode of operation 402. The process of detecting the high power satellite is termed as low-sensitivity dwell mode of operation 402 because the sensitivity of the receiver 102 needed to detect the satellite signal 110 with higher power level is low compared to the sensitivity of the receiver 102 needed to detect the low power satellite. In contrast, the process in which the receiver 102 detects a low power satellite is termed as a high-sensitivity dwell mode of operation 406. In one or more embodiments, once the high power satellite signal is detected, a second process is initiated.

In the second process, the receiver 102 uses the high power satellite signal that is acquired during the low-sensitivity dwell mode of operation 402 and/or an external assistance data (e.g., in assisted GPS, SV differences) to reduce the 2-D search space 200. The 2-D search space 200 is reduced by removing the arrival time T_{c} offset and Doppler frequency f_{d} offset. The arrival time and Doppler frequency offset is caused by multiple reasons such as satellite 106 motion and/or clock synchronization error, etc. In one or embodiments, the external assistance data includes an information message showing the estimate difference in code phase and Doppler frequency offset between the detected satellite and the remaining satellites. External assistance is provided by a network service, mobile phone network, a wireless network, a combination of a wired and wireless network, and/or an internet service provider. Once the 2-D search space 200 is reduced, a third process is initiated. Upon detecting one satellite 106 the receiver 102 knows an approximate clock time offset and/or frequency offset. Removing the offset reduces the 2-D search space 200 in coarse time assisted scenarios.

In the third process, the receiver 102 initiates the high-sensitivity dwell mode of operation 406 in the reduced search space to detect a low power satellite using a coherent integration time period that is synchronized to the transmission rate of the information data bit 310. The coherent integration time period used in the current signal acquisition strategy 400 is 19 ms. Since the coherent integration time period is synchronized with the transmission rate of the information data bit 310, a bit edge related loss 702 occurs. The sensitivity of the receiver 102 is reduced as a result of a bit edge related loss 702. For example, if a coherent integration time period of 19 ms is used when the transmission rate of the information data bit 310 is 20 ms, a bit edge related loss 702 occurs which results in a reduced sensitivity of the magnitude of 1.6 dB. As a result, the receiver 102 with reduced sensitivity is able to detect weak satellite signals. Detection of the weak satellite signals by the receiver 102 is limited due to reduced sensitivity of the receiver 102 and sensitivity of the receiver 102 to low power satellite signals is constrained. The switching module 104 of the receiver 102 improves the sensitivity of the receiver 102 and thereby improves the efficiency (e.g., signal detection capability, time to receive first position fix, start up time, robustness, coverage of receivers' position fix, ability to acquire satellites with low power satellite signals) of the receiver 102.

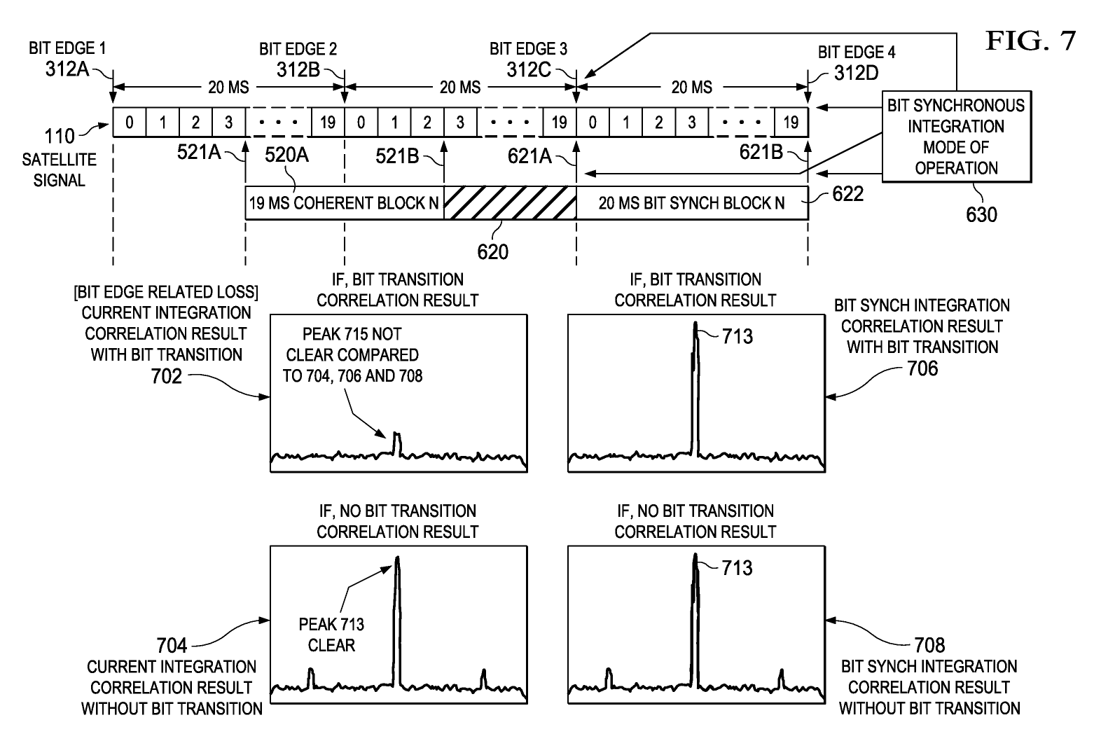

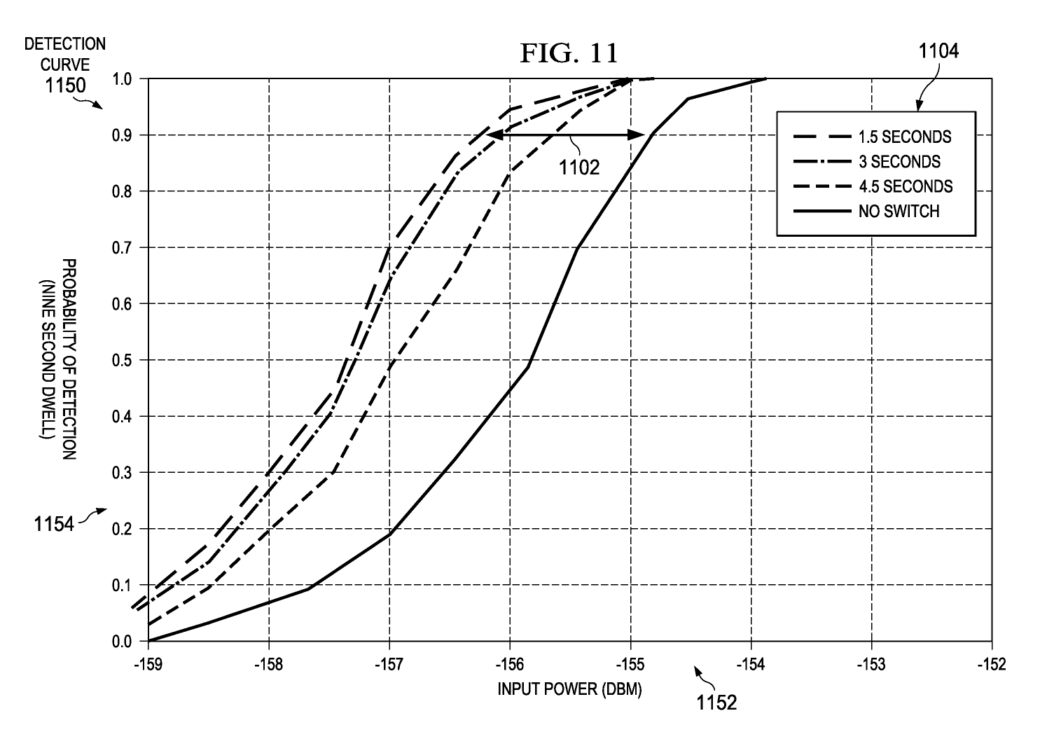

The bit edge related loss 702 and sensitivity change 1102 related to a receiver 102 is described in the forthcoming FIGS. 7 and 11 respectively. However, a description of the bit edge related loss 702 and sensitivity changes related to a receiver 102 requires an understanding of the current integration mode of operation 500 and the bit-synchronous integration mode of operation 630.

FIG. 5 is a diagram illustrating a current integration mode of operation 500. In FIG. 5, a received satellite signal 110 and a number of hypothetical 19 ms coherent integration block 520a-c using an integration time period of 19 ms, is shown. The current integration mode of operation 500 includes a time-domain integration operation comprising a coherent integration operation, a coherent averaging operation or a time-domain averaging operation. The received satellite signal 110 is cross correlated with a replica of the signal generated by the receiver 102. The correlation result is then integrated over a time period to detect the satellite 106 or acquire the satellite signal 110.

Since, in one or more embodiments, the bit edges 312a-d of the information data 302 in the satellite signal 110 from the satellite 106 that is being detected is not known, the receiver 102 is not able to use a coherent integration time period that is synchronized with transmission rate of information data bit 310 (e.g., navigation message with a transmission rate of 50 bps or 1 bit per 20 ms). The satellite signal 110 includes a low power satellite signal. As a result, in FIG. 5 the bit edges 312a-d straddle through the coherent integration blocks 520a-c. The straddling of the bit edges 312a-d occurs if the bit edges 312a-d of the information data 302 in the received signal 110 are not aligned with the starts of the 19 ms coherent integration block 521 a-d. Instead the bit edge 312 falls in between the start and end of the coherent integration block 520. For example, bit edge 312b of the received signal 110 is not aligned with the start 521a-d of any of the 19 ms coherent integration blocks 520a-c. The bit edge 312b of the received signal 110 is not aligned with the start 521a-d of any of the 19 ms coherent integration blocks 520a-c because in the current integration mode of operation 500, the coherent integration blocks 520a-c are synchronized with the received signal 110 in time period and the start 521a-d of the coherent integration block 520a-c is not aligned to the bit edges 312a-d of the received satellite signal 110. The straddling bit edges 312a-d leads to a bit edge related loss 702 which in turn may reduce the sensitivity of the receiver 102. Reducing the sensitivity of the receiver 102 decreases the ability of the receiver 102 to detect low power satellites or low power satellite signals with low received signal strength (e.g., between −140 dBm and −160 dBm), in a threshold amount of time.

FIG. 6 is a diagram explaining a bit-synchronous integration mode of operation 630 and the dynamic switch operation from current integration mode of operation 500 to a bit-synchronous mode of operation 630, according to one or more embodiments. The bit-synchronous integration mode of operation 630 is a coherent integration mode of operation which is aligned to the start of the bit 312 and the time interval between the bits 312a-d. The time interval between each consequent bit pair from the bits 312a-d may be 20 ms. The received satellite signal 110 which is correlated with a replica signal generated by the receiver 102, is integrated over a time period to accumulate as much signal energy as possible after the correlation. A very high coherent integration time period is required since it enables the receiver 102 to detect signals with low received signal strength (e.g., low power satellite signals). However, there are limitations to increasing the time period of the coherent integration block 520. The preferred integration time period that are used would be an integration time period that is aligned or synchronized with the transmission rate of the information data 302 (e.g., navigation message with transmission rate of 50 bps). The integration mode of operation whose time period is synchronized with the transmission rate and bit edge 312 of the information data bit 310 is termed as bit-synchronous integration mode of operation 630.

Once the bit edge 312 of the information data 302 in the satellite signal 110, from the satellite 106 that is being detected is determined, the coherent integration block 520b is dynamically switched to a bit synchronized integration mode of operation using a 20 ms bit synchronized integration block 622. The received satellite signal 110 is a low power satellite signal. Once the bit edge 312 of the low power satellite signal is determined, the coherent integration block is abandoned and within the same dwell mode of operation the integration is dynamically switched to 20 ms bit-synchronous mode of operation. In FIG. 6, 620 represents the abandoned 19 ms coherent integration block within the dwell in which the bit edge 312 is detected. The bit edge 312 of the low power satellite signals is determined or calculated through assistance from the high power satellite signal detected in the low-sensitivity dwell mode of operation 402 of the current integration mode of operation 500. Within a specific dwell, the bit edge 312 is determined in the coherent integration block 620 as per FIG. 6. Starting 621a of the bit-synchronous integration block 622 is aligned with the bit edge 312c of the received satellite signal 110 and the end 621b of the bit-synchronous integration block 622 is aligned with the bit edge 312d of the received satellite signal 110. The time period of the bit-synchronous integration block 622 is also aligned with the transmission rate of data bits 310 in the information data 302 that is embedded in the received satellite signal 110. In FIG. 6, the dynamic switch to bit-synchronous integration mode of operation 626 portrays the transition from the 19 ms coherent integration block 520 to 20 ms bit-synchronous integration block 622. Using a bit-synchronous integration mode of operation 630 eliminates the bit edge related loss 702 that occur through using a coherent integration mode of operation that is not bit synchronized or bit aligned.

FIG. 7 is a diagram projecting the bit edge related loss 702 while using a current integration mode and an elimination of the bit edge related loss 702 using bit-synchronous integration mode of operation 630, according to one or more embodiments. The received satellite signal 110 includes bit edge 312a-d spaced 20 ms apart based on the transmission rate of the navigation message from the GPS satellite. When the receiver 102 obtains the received signal 110, the receiver 102 starts a correlation process followed by an integration operation.

Since, initially the receiver 102 does not have the bit edge 312 of information data 302 in the received satellite signal 110, the receiver 102 does not enter the integration mode of operation with integration blocks of 20 ms time period. Instead, the receiver starts the integration mode of operation with a time period of 19 ms. Upon determining the bit edge 312, which is in another parallel detection operation, the current integration operation is dynamically switched to the bit-synchronous integration mode of operation 630. The dynamic switch to the bit-synchronous integration mode of operation 626 occurs in a dwell mode of operation in which the bit edge 312 has been detected. In one embodiment, the bit-synchronous integration mode of operation 630 uses a bit-synchronous integration block 622 having a time period of 20 ms.

As described earlier, the information data bits 310 in the information message flips between a −1 and +1 value in an arbitrary yet defined sequence, throughout the received signal with a 20 ms interval between each information data bit edge 312a-d. If the bit 310 transition happens to occur in between the integration period, which does not include the start and end time instance of the time period, and the bit edge 312 transitions along with that, then the bit 310 transition causes the signals to be added destructively. The addition of the signals destructively results in a correlation result with no clear peak 715 and hence ability to detect the satellite 106 becomes poor or the time taken to detect the satellite 106 is long. The destructive addition of correlated signals due to bit 310 transitions in between the coherent integration period is termed as the bit edge related loss 702 which is represented by 702. A result of the bit edge related loss 702, either the receiver 102 takes longer time to fix the position initially or the receiver 102 is not able to detect low power satellites or low power satellite signals.

On the contrary, when the bit edges 312 of the received satellite signal 110 and the time period between each bit edges 312a-d in the received satellite signal 110 are aligned with the time period and starts 621a-b of the integration blocks 622 of the receiver 102, the signals add constructively as shown in 706. This results in a clear peak 713 in the correlation result which improves the detection ability of the receiver 102 compared to when there is no clear peak 715. If there are no bit 310 transitions, for example if bit edges 312a-d are all +1, then integrating with an time period which is not aligned to the bit edges 312a-d produces a constructive addition of signal with a clear correlation peak 713 as shown in 704 and 708. The switching module 104 in the receiver 102 employs a switching mode of operation that addresses the bit edge related loss 702 and thereby the switching module 104 improves the efficiency of the receiver 102 in terms of signal detection capability.

FIG. 8 is a flow diagram of the switching mode of operation 600 performed by switching module 104 in the receiver 102, according to one or more embodiments. Further in FIG. 8, the switching mode of operation 600 is compared to the current signal acquisition strategy 400 involving a coherent integration mode of operations. A switching mode of operation 600 addresses the bit edge related loss 702 in signal acquisition by dynamically switching from current integration mode of operation 500, which is not synchronized with bit 310 transmission of navigation message to a bit synchronized integration mode of operation, within a dwell period. In other words, in a particular dwell period once the bit edge 312 of the information data 302 in the satellite signal 110 is obtained from the satellite 106 that is being detected, the remaining dwell period is switched from a current integration mode of operation 500 to a bit-synchronous integration mode of operation 630. This satellite signal 110 is a low power satellite signal that is generated by the satellite 106 which is obstructed with respect to the receiver 102 by surrounding environment 108. A switch is activated upon obtaining the bit edge 312 of the information data 302 included in the satellite signal 110, generated by the satellite 106. A switching operation is performed by the switching module 104 of the receiver 102. The switch to bit synchronized integration mode of operation eliminates the bit edge related loss 702.

The switching mode of operation follows four processes. The receiver 102 in the first process 802, starts a low-sensitivity dwell mode of operation 402 and detects a high power satellite signal which is similar to the first process of the current integration mode of operation 500.

However, the second process 804 in the switching mode of operation 800 funds the bit edge 312 of the information data 302 from the high power satellite signal acquired in the first process as compared to solely the process of removing arrival time Tc and Doppler frequency fd offsets to reduce the 2D search space that is done in the second process of the current integration mode of operation 500. In the third process 806 the bit edge 312 of information data 302 in other low power satellite signals is calculated using the information from the detected bit edge 312 in the second process 804. In an embodiment, the third process 606 occurs in parallel to the fourth process 808.

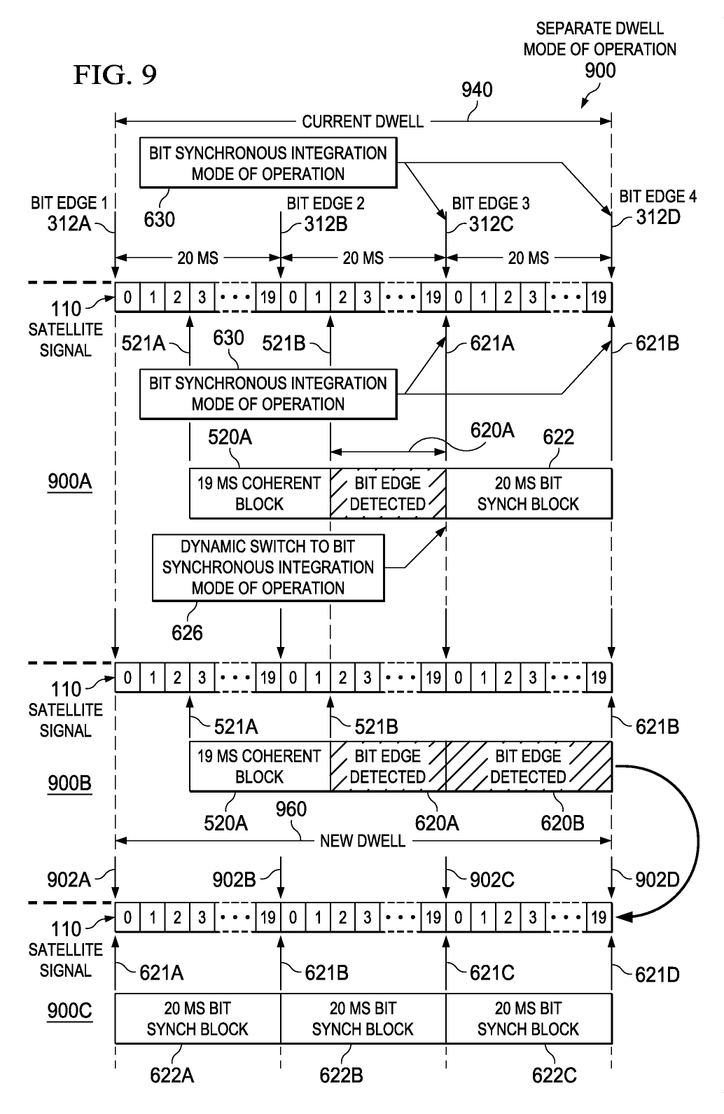

The receiver 102 in the fourth process starts the high-sensitivity dwell mode of operation 406 with a coherent integration time period that is not synchronized to the bit edge 312 transmission rate of the information data 302 in the reduced search space. However, in the switching mode of operation 800, when the bit edge 312 of information data 302 in low power satellite signals is detected, the integration mode of operation in the high-sensitivity dwell mode of operation 406 is dynamically switched from current integration mode of operation 500 to a bit synchronized integration mode of operation 630. The dynamic switch to bit-synchronous integration mode of operation 626 happens in the current dwell operation 940 in which the bit edge 312 was determined as shown in 900a of FIG. 9. Alternately, the current dwell operation 940 is abandoned as shown in 900b and a new dwell operation 960 can be initiated with bit synchronized integration mode of operation as shown in 900c of FIG. 9. The switching module 104 aids in the switching operation from current integration mode of operation 500 to a bit-synchronous integration mode of operation 630.

FIG. 9 is a diagram showing another aspect of the switching operation to the bit-synchronous mode of operation in a new dwell 942 separate from the dwell during which the bit edge 312 information is determined (e.g., current dwell 940), according to one or more embodiments. Current dwell period includes the dwell period during which the bit edge 312 is determined. In switching to bit-synchronous integration mode of operation 630 as described earlier, the integration block 522b in which the bit edge 312 is detected is abandoned and the integration operation is dynamically switched to a bit synchronized integration mode of operation in the current dwell operation 940 operation as shown in 900a. In FIG. 9, label 626 indicates the dynamic switch to bit-synchronous integration mode of operation. Abandoning a coherent integration block 620 indicates that the remaining integration time period in a coherent integration block after the bit edge 312 is detected is skipped and the next nearest bit edge 312 ahead in time may be chosen to start alignment of the bit-synchronous integration block 622, within the current dwell period. However, in one embodiment, once the bit edge 312 may be determined during the 19 ms time period coherent integration operation block 620 in a current dwell operation 940, the switching module 104 abandons the remaining integration in the current dwell operation 940 as shown in 900b and starts a new dwell 960 in which the integration operation used is the bit-synchronous integration mode of operation 630 as shown in 900c. Each 20 ms bit-synchronous integration block 622 is aligned with the bit edges 902a-d in the received signal 110 of the new dwell 960.

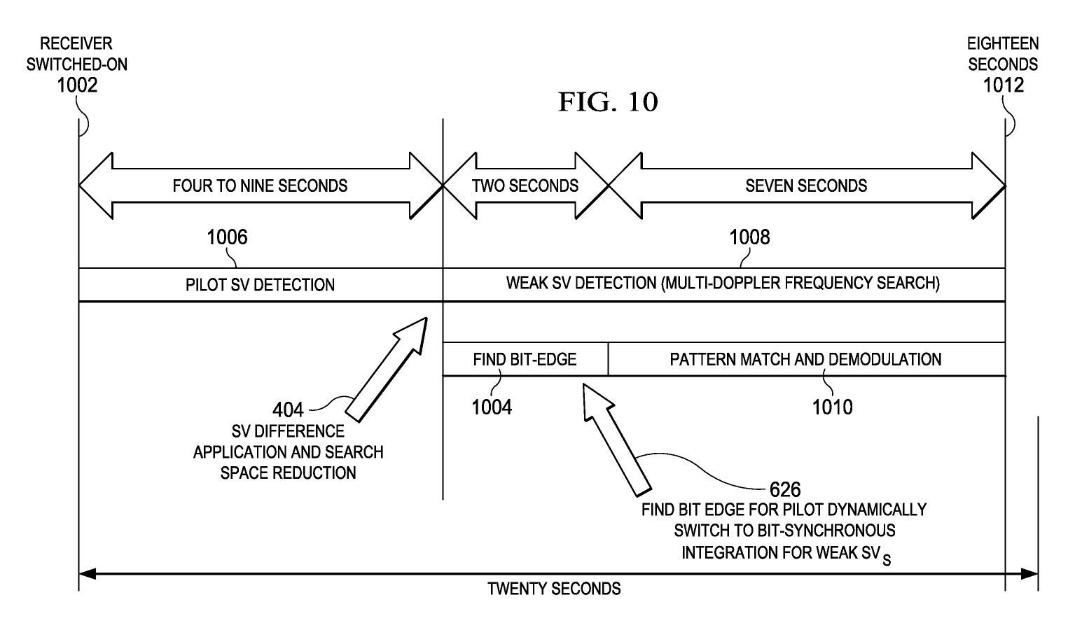

FIG. 10 is a time line diagram of the various operations in a satellite acquisition process of the receiver 102, from the time the receiver 102 is switched on 1002 to the time the first position fix is obtained 1012, through a usage of the dynamic switching to bit-synchronous mode of operation 626. The time frame between switching on 1002 a receiver 102 to the time taken for the receiver 102 to obtain a first position fix 1012 varies to at most 18 sec. Obtaining a position fix within 20 sec is a 3GPP test requirement in coarse time assisted scenarios. The time frame between switching on 1002 a receiver 102 to the time taken for the receiver 102 to obtain a first position fix 1012 is divided into two sections. In the first section, the receiver 102 scans for and detects a high power satellite signal. The detection of the first satellite may be termed as pilot SV detection 1006. The time period to determine the pilot SV varies based on the hardware search capacity of the receiver 102(e.g., 4 sec to 9 sec).

Once the bit edge has been determined the pattern match and demodulation operation enables the receiver 102 to find the sub frame boundaries in the satellite signal 110. The sub frame boundaries enable the receiver to derive an exact time of the received satellite signal 110. The exact time is termed as full integer-ms time. The exact time of the received satellite signal 110 provides an exact satellite position determination. In one or more embodiments, without the full integer-ms time, even if the receiver 102 detects 4 SV's a position fix may not be obtained. If the receiver 102 does not find the full integer-ms time, there may be another technique termed SFT (Solve For Time) which may require 5 SV's to give a position fix.

Once the pilot SV may be detected, the second section may begin in which the receiver 102 may search for other satellites (e.g., weak or low power satellites). Searching for other satellites may involve finding the bit edge 312 of other satellites (e.g., weak or low power satellites) 1004. The bit edge 312 may be found 1004 by calculating the bit edge 312 of other satellite signals (e.g., low power satellite signals) using the bit edge 312 of the pilot SV that may have been determined in the first section. At the end of the pilot SV detection section, the SV differences application 404 operation may be used to reduce the 2-D search space. Within the current dwell operation 940, if the bit edge 312 of other satellite signals (e.g., low power satellite signals) is detected then the remaining time period of the current dwell 940 is dynamically switched from the current integration mode of operation 500 to the bit-synchronous mode of integration. The dynamic switch to bit-synchronous integration mode of operation may be indicated by 626 in FIG. 10. The bit-synchronous integration mode of operation 630 enables detection of the low power satellites and a combination of the satellite signal 110 from four satellites may be used by the receiver 102 to generate the first position fix after the receiver 102 has been switched on.

The time taken to calculate the bit edge 312 of the low powered satellite from the bit edge 312 of the high powered satellite acquired in the first section may vary (e.g., at most 2 sec) based on the efficiency of a bit edge 312 calculation algorithm being used. The time that is spent on detection of the bit edge 312 of the low power satellite, in the second section affects the improvement in sensitivity, wherein sensitivity of the receiver 102 is the lowest receive power level of the satellite signal 110 which the receiver may detect. Improving the sensitivity may imply that the receiver 102 may detect even lower receive power levels of the satellite signal 110.

FIG. 11 is a graph showing the probability of detection of the satellite 106 at various input powers when the dynamic switching is enabled in comparison to when the dynamic switching may not be enabled from the current integration mode of operation 500 to the bit-synchronous integration mode of operation 630 in the receiver 102. The graph also depicts the sensitivity increase of the receiver 102 by dynamically switching the current integration mode of operation 500 to the bit-synchronous integration mode of operation 630. The horizontal axis of the graph may represent the input powers 1152 of the satellite signal 110. The input powers 1152 may be measured in decibels, wherein the input power of the satellite signal 110 may be the received signal strength of the satellite signal 110 generated and transmitted by the satellite 106 and received by the receiver 102. The vertical axis in the graph may represent the probability of detection 1154 of the satellite 106. The horizontal axis and the vertical axis may be related based on an explanation that the probability of detection 1154 of a satellite 106 may vary with change in input power 1152 or received signal strength of the satellite signal 110 from the satellite 106.

The graph shows the lowest received signal strength of the satellite signal 110 from the satellite 106 that can be used to detect the satellite 106 with a probability of detection of 0.9. In other words, the graph depicts the lowest signal strength of the satellite signal 110 from the satellite 106 (used as lowest signal strength hereafter) that is needed to detect the satellite 106 with a 90% probability. From the graph in FIG. 11, it can be seen that the lowest signal strength required to detect the satellite 106 may vary when the current integration mode of operation 500 is dynamically switched to the bit-synchronous integration mode of operation 630. The current integration mode of operation 500 may be a 19 ms coherent integration mode of operation and the bit-synchronous integration mode of operation 630 may be a 20 ms bit-synchronous integration mode of operation 630.

In one or more embodiments, a high-sensitivity dwell time of 9 sec may be used. In one or more embodiments, the high-sensitivity dwell time of 9 sec 1008 may be divided into two parts as explained in FIG. 10. In one or more embodiments, the first part 1004 may be used to find the bit edge 312 of the satellite signal 110. In one or more embodiments, the satellite signal 110 in the high-sensitivity dwell mode of operation 406 may be a low power satellite signal. Once the bit edge 312 of the satellite signal 110 is detected, the second part may be initiated. In one or more embodiments, the second part 1010 may be a pattern match and demodulation operation.

In one or more embodiments, the time taken to find the bit edge 312 of the satellite signal 110 associated with the satellite 106 may vary based on the bit calculation algorithm that is used. In one or more embodiment, any known bit calculation method may be used. In one or more embodiments, when the bit edge 312 is found in 1.5 sec into the 9 sec high-sensitivity dwell time, the sensitivity may increase by 1.6 db as shown by 1102 i.e. when the dwell is not switched to a bit-synchronous integration mode of operation 630 from the current integration mode of operation 500 the receiver 102 may require an input power of −155 dBm to detect a satellite 106 with 0.9 probability and when the bit edge 312 is found in 1.5 sec into the dwell and the dynamic switch to bit-synchronous integration mode of operation 626 is made in 1.5 sec into the dwell, the input power that may be required by the receiver 102 to detect the satellite 106 with 0.9 probability may be reduced by 1.6 dB to −156.6 dBm. In one or more embodiments, when the receiver 102 is able to detect low power satellites, the receiver 102 may be said to have high-sensitivity i.e. the receiver 102 may become more sensitive to weak satellite signals. For example, in FIG. 11 for a 90% probability of detection, the receiver 102 detects a satellite whose input power is −155 dB when there is no switch and when the switch operation is applied the receiver 102 is able to detect a satellite whose input power is 1.6 dB lesser at −156.5dB. Upon applying the switch the ability of the receiver 102 to detect a satellite with 1.6 dB lesser input power than when the switch is not applied may be termed as increased sensitivity. The sensitivity increase of 1.6 dB may be indicated by 1102 in FIG. 11. The time taken to find the bit edge 312 may also depend on the actual power level of the pilot SV. If the pilot SV power is very high then the time taken to find the high power satellites bit edge may be short else it may be longer.

In one or more embodiments, if the receiver 102 finds the bit edge 312 after 3 sec or 4.5 sec into the dwell as shown by the legend 1104 in FIG. 11, the sensitivity improvement may be reduced to 1.1 dB and 0.6 dB respectively for a 0.9 probability of detection. The earlier receiver switches to bit synchronous integration, the better it is.

An increase in sensitivity of the receiver 102 may improve the detection ability of the receiver 102. In one or more embodiments, the improvement in detection ability may be based on, but not limited to, the improved signal detection ability in a GPS receiver. The various modules in the receiver 102 and how the various modules in the receiver 102 may interact with one another and with the switching module 104 to improve the detection ability of the receiver 102 is explained in FIG. 12.

FIG. 12 is a block diagram illustrating an exploded view of the receiver 102 with interaction between the switching module 104 and a set of other modules of the receiver 102, according to one or more embodiments. In one or more embodiment, the receiver 102 may have a detection module 1208, a calculation module 1210, a correlation module 1202, an accumulation module 1204, an alignment module 1212, a locking module 1214 and a search module 1206 being coupled to a switching module 104. In one or more embodiments, the correlation module 1202 may be coupled to the accumulation module 1204, the detection module 1208 may be coupled to the calculation module 1210, and all the above mentioned modules 1202-1214 may be communicatively coupled to the switching module 104 through a bidirectional coupling.

In one or more embodiments, the receiver 102 may have a correlation module 1202 which may correlate the received satellite signal 110 with a replica code (e.g., CIA code, Gold code, P(Y) code) generated by receiver 102 to determine the presence of the satellite 106. In one or more embodiments, the receiver 102 may have an accumulation module 1204. In one or more embodiments, the accumulation module 1204 may integrate the correlation results to obtain a clear correlation peak, which may indicate detection of a satellite 106. For each accumulation operation, correlation may be followed by accumulation of correlation results. The accumulation may be a combination of coherent and non coherent integration. For example, the accumulation may be a combination of a coherent integration period of 19 ms and non coherent integration of the coherently integrated values. The number of non coherent integrations is 475 (9 sec divided by 19 ms) assuming a 9 sec dwell time.

In one or more embodiments, the output of the correlation module 1204 may be provided to the input of the accumulation module 1204 to integrate the correlated result over a certain time period. The certain time period may be a coherent integration time period, non coherent integration time period, time domain accumulation time period, predetection integration time period, time averaging integration time period and/or a bit synchronized integration time period. The time period referred above may be a combination of coherent and non coherent integration operation time periods. The coherent integration may be 20 ms which is bit synchronized. If the coherent integration is not bit synchronized the coherent integration time period may be 19 ms, 1 ms, 3 ms or 5 ms or several other combinations. In one or more embodiments, the receiver 102 may have a search operation module 1206, wherein the search operation module 1206 may search a multi dimensional search space (e.g., 2 dimensional 200) for various characteristic features of the satellite signal 110 (e.g., arrival time, Doppler frequency, carrier phase) that enables determination of one of the position, navigation, direction and time related information. The search operation performed by the receiver 102 may include correlation of the received satellite signal with a replica of the satellite signal generated by the receiver 102 and then integrating the result of the correlation. In one or more embodiments, the receiver 102 may have an alignment module 1210 which may change a 19 ms coherent integration block to a 20 ms coherent integration block and align the 20 ms coherent integration block to the bit edge 312 of the received satellite signal of the low power satellites. The alignment module may align the coherent integration integration block to the bit boundaries. The bit synchronous integration block may be a coherent integration block aligned to the bit boundaries of the received signal. The bit synchronous integration block may also be aligned in integration time. The locking module 1214 may associate the detected satellite 106 with the receiver 102.

In one or more embodiments, the receiver 102 may have a detection 1208 that may determine the bit edge 312 of the received satellite signal 110 associated with the satellite 106. The detection module 1208 may also perform a detection operation to detect the low power satellites. The detection operation may also be termed as the high-sensitivity dwell mode of operation 406. In one or more embodiments, the receiver 102 may have a calculation module 1210 coupled with the detection module 1208. The calculation module 1210 may calculate the bit edge 312 of the low power satellite signal received using the bit edge 312 of the detected high power satellite signal which is detected in the detection module 1208.

In one or more embodiments, the ability of a receiver 102 to determine a position, a velocity, an acceleration, a direction, a time and/or a navigation information may be improved when the switching module 104 in the receiver 102 receives an input from all the modules and makes an informed decision based on the input. The informed decision made by the switching module 104 may relate to switching a current integration mode of operation 500 to a bit-synchronous integration mode of operation 630. The informed decision made by the switching module 104 in the receiver 102 may also involve whether to dynamically switch the integration mode of operation within a current dwell time 940 in which a bit edge 312 of the received satellite signal 110 may have been detected or to whether to start a new dwell operation 960 with bit-synchronous integration mode of operation 630. The switching of current integration mode of operation 500 to bit-synchronous integration mode of operation 630 may improve an efficiency of the receiver 102 (e.g., signal detection capability, time to receive first position fix, start up time, robustness, coverage of receivers' position fix, ability to acquire satellites with low power satellite signals). The application of the dynamic switch to bit synchronous mode of integration and/or starting a new dwell with bit synchronous integration mode of operation may be extended to a receiver 102 which may employ GLONASS, Galileo and/or hybrid receivers. The hybrid receiver may be a combination of GPS, GLONASS and Galileo positioning systems.

Although the present embodiments have been described with reference to specific example embodiments, it will be evident that various modifications and changes may be made to these embodiments without departing from the broader spirit and scope of the various embodiments. For example, the various systems, devices, apparatuses, and circuits, etc. described herein may be enabled and operated using hardware circuitry, firmware, software or any combination of hardware, firmware, or software embodied in a machine readable medium. The various electrical structures and methods may be embodied using transistors, logic gates, application specific integrated (ASIC) circuitry or Digital Signal Processor (DSP) circuitry.

In addition, it will be appreciated that the various operations, processes, and methods disclosed herein may be embodied in a machine-readable medium or a machine accessible medium compatible with a data processing system, and may be performed in any order. Accordingly, the specification and drawings are to be regarded in an illustrative rather than a restrictive sense.

What is claimed is:

1. A method comprising:
determining a bit edge associated with information transmitted from a satellite during a detection operation of a receiver through a processor associated therewith; and
dynamically switching, through the processor, a mode of a signal acquisition of the receiver from a current integration mode of operation of a measurement to a bit-synchronous integration mode of operation of the measurement using the processor when the bit edge is determined.

2. The method of claim 1, wherein:
the bit-synchronous integration mode of operation is activated in a separate detection mode of operation to one in which the bit edge is determined, the bit-synchronous integration mode of operation being a variant of the current integration mode of operation,
the variant of the current integration mode of operation accumulates a correlation result by aligning a time period of an accumulation operation with a time period between consequent bit edge associated with the information transmitted from the satellite and aligning a start of the accumulation operation with the start of the bit edge,
the information transmitted from the satellite is in a form of one of a navigation message, and
the current integration mode of operation is at least one of a coherent integration, a predetection integration and a non-coherent integration operation.

3. The method of claim 1, wherein the detection operation is a high-sensitivity dwell mode of operation in which the satellite is identified, wherein the high-sensitivity dwell mode of operation is a search operation, and wherein the satellite is obstructed from view with respect to a satellite receiver when interference is caused in a surrounding environment, and wherein the satellite is part of a space-based global navigation satellite system providing at least one of a positioning service, a navigation service, and a timing service to worldwide users on a continuous basis at any location when the receiver has a view of at least four satellites.

4. The method of claim 3, further comprising:
applying the bit-synchronous integration mode of operation during the high-sensitivity dwell mode of operation; and
increasing a sensitivity of the receiver through the bit-synchronous integration mode of operation.

5. The method of claim 4, further comprising:
aligning the receiver generated signal with a satellite generated signal through the bit-synchronous integration mode of operation;
associating the receiver with the satellite; and
improving a signal detection of a GPS when the bit-synchronous integration mode of operation is applied.

6. The method of claim 5, wherein a sensitivity improvement is at least 1.6 decibels when a 19 millisecond coherent integration period is dynamically switched to a 20 millisecond bit-synchronous integration period.

7. The method of claim 1, wherein the current integration mode of operation is a time-domain integration operation comprising at least one of a coherent integration operation, a coherent averaging operation, and a time-domain averaging operation.

8. The method of claim 1 is in a form of a machine-readable medium embodying a set of instructions that, when executed by a machine, cause the machine to perform the method of claim 1.

9. A receiver comprising:
a detection module to determine a bit edge during a high-sensitivity dwell mode of operation of the receiver in which a satellite is identified; and
a switching module to switch from a current integration mode of operation of a measurement to a bit-synchronous integration mode of operation of the measurement using a processor when the bit edge is determined during the high-sensitivity dwell mode of operation of the receiver.

10. The receiver of claim 9:
wherein the bit-synchronous integration mode of operation is activated in a separate detection operation to one in which the bit edge is determined,
wherein the bit-synchronous integration mode of operation is a variant of the current integration mode of operation,
wherein the variant of the current integration mode of operation to accumulate a correlation result over numerous iterations by aligning a time period of an accumulation operation with a time period between consequent bit edge associated with information transmitted from the satellite and aligning a start of the accumulation operation with the start of the bit edge,
wherein the information transmitted from the satellite may be in a form of one of a navigation message, and
wherein the current integration mode of operation is at least one of a coherent integration, a predetection integration and a non-coherent integration operation.

11. The receiver of claim 10:
wherein the hit-synchronous integration mode of operation is applied during the high-sensitivity dwell mode of operation,
wherein the high-sensitivity dwell mode of operation is a search operation that determines the satellite,
wherein the satellite is obstructed from view with respect to a satellite receiver when interference is caused by a surrounding environment,
wherein the satellite is part of a space-based global navigation satellite system providing at least one of a positioning service, a navigation service, and a timing service to worldwide users on a continuous basis at any location when the receiver has a view of at least four satellites, and
wherein a sensitivity of the receiver is increased through the bit-synchronous integration mode of operation.

12. The receiver of claim 11 further comprising:
a locking module to associate the receiver with the satellite; and
an alignment module to synchronize the receiver generated signal with a satellite generated signal through the bit-synchronous integration mode of operation, wherein a signal detection of a GPS is improved when the bit-synchronous integration mode of operation is applied.

13. The receiver of claim 9 wherein the current integration mode of operation is a time-domain integration operation comprising at least one of a coherent integration operation, a coherent averaging operation, and a time-domain averaging operation.

14. A global positioning system comprising:
a satellite to generate a satellite signal; and
a receiver to switch from a current integration mode of operation of a measurement to a bit-synchronous integration mode of operation of the measurement when a bit edge of the satellite signal is determined during a detection operation of the receiver .

15. The global positioning system of claim 14:
wherein the bit-synchronous integration mode of operation is activated in a separate detection operation to one in which the bit edge is determined,
wherein a high-sensitivity dwell mode of operation is a search operation that determines the satellite,
wherein the satellite is obstructed from view with respect to a satellite receiver when interference is caused by a surrounding environment, and
wherein the satellite is part of a space-based global navigation satellite system providing at least one of a positioning service, a navigation service, and a timing service to worldwide users on a continuous basis at any location when the receiver has a view of at least four satellites.

16. The global positioning system of claim 15:
wherein the bit-synchronous integration mode of operation is applied during the high-sensitivity dwell mode of operation, and
wherein a sensitivity of the receiver is increased through the bit-synchronous integration mode of operation,
wherein the bit-synchronous integration mode of operation is a variant of the current integration mode of operation,
wherein the variant of the current integration mode of operation to accumulate a correlation result over numerous iterations by aligning a time period of an accumulation operation with a time period between consequent bit edge associated with information transmitted from the satellite and aligning a start of the accumulation operation with the start of the bit edge,
wherein the information transmitted from the satellite may be in a form of one of a navigation message, and
wherein the current integration mode of operation is at least one of a coherent integration, a predetection integration and a non-coherent integration operation.

17. The global positioning system of claim 16:
wherein a sensitivity improvement is at least 1.6 decibels when a 19 millisecond coherent integration period is dynamically switched to a 20 millisecond bit-synchronous integration period.

18. The global positioning system of claim 17, further comprising:
a locking module of the receiver to associate the receiver with the satellite; and
an alignment module of the receiver to synchronize the receiver generated signal with a satellite generated signal through the bit-synchronous integration mode of operation.

19. The global positioning system of claim 18, wherein a signal detection of a GPS is improved when the bit-synchronous integration mode of operation is applied.

20. The global positioning system of claim 14, wherein the current integration mode of operation is a time-domain integration operation comprising at least one of a coherent integration operation, a coherent averaging operation, and a time-domain averaging operation.
